(19) United States
(12) Patent Application Publication
(10) Pub. No.: US 2002/0167449 A1
(43) Pub. Date: Nov. 14, 2002

(54) Low profile phased array antenna

(76) Inventors: Richard Frazita, St. James, NY (US); Lawrence Rytter, Hunt Valley, MD (US)

Correspondence Address: Attention: Thomas A. O'Rourke, Wyatt, Gerber & O'Rourke, L.L.P., 99 Park Avenue, New York, NY, 10016, US

(21) Appl. No.: 09/986,018

(22) Filed: Oct. 22, 2001

Related U.S. Application Data
(60) Provisional application No. 60/242,344, filed on Oct. 20, 2000.
(60) Provisional application No. 60/242,345, filed on Oct. 20, 2000.
(60) Provisional application No. 60/242,346, filed on Oct. 20, 2000.

(51) Int. Cl. H01Q 19/06; H01Q 19/00; H01Q 3/00

(52) U.S. Cl. 343/756; 343/754; 343/757

(57) ABSTRACT

An improved phased array antenna having a low profile is disclosed. The antenna has a polarizer and a rotating phased array. MEMS phase shifters are used for electronically controlling relative phase shift between antenna elements and MEMS switches employed to provide beam steering and polarization switching.

Priority is claimed based on U.S. Provisional Patent Applications Serial Nos. 60/242,344, 60/242,345, and 60/242,346 filed on Oct. 20, 2000 the disclosures of which are incorporated herein by reference.

### FIELD OF THE INVENTION

The present invention relates to improvements in antennas and more particularly phased array antennas that have a low profile on a building, and on vehicles including aircraft ships etc. In particular, the present invention is directed to low profile, electronic scanned phased array antennas

### BACKGROUND OF THE INVENTION

Over the last few years the public's reliance on computer networks including but not limited to the Internet has increased exponentially. Many people today use the Internet for many aspects of their business and personal lives. One of the problems with the Internet for many users is the download speeds that are currently available to many parts of the nation. Most modems using telephone lines achieve speeds of not greater that about 56 kps. Cable modems and DSL lines can achieve significantly greater speeds than 56 kps but the services necessary for these products are not currently available in many parts of the country. One of the reasons why cable and DSL lines are not available in many parts of the country is due to the high cost of building the infrastructure necessary to provide these services in many areas for the foreseeable future. In order to obtain broadband Internet access in places where cable and DSL lines are not available many people are looking to their satellite television provider to provide broadband Internet access. It is expected that this service will be offered commercially in the near future if it is not already available.

Even in many parts of the country where cable television is available, there are still a fair number of people who would prefer to obtain their television programming from one of the many satellite television providers such as DirectTV. Many of these satellite providers tout the vast array of channels that a viewer can receive through a satellite compared to the number of channels that are available through the local cable operator. Some satellite television providers provide in excess of 400 channels whereas cable operators typically offer 80 to 120 stations.

Satellite broadcasting is made possible by the fact that communications satellites are fixed in geosynchronous orbit 22,300 miles above the equator, staying in the same position above the ground at all times. This allows satellite antennas that transmit and receive signals to be aimed at an orbiting satellite and left in a fixed position. Satellite programmers broadcast, or uplink, signals to a satellite which they either own or lease channel space from. The signals are often scrambled, or encrypted, to prevent unauthorized reception before they are retransmitted to a home antenna.

The uplinked signals are received by a transponder located on the satellite, a device that receives the signals and transmits them back to the earth after converting them to a frequency that can be received by a ground-based antenna. Typically there are 24 to 32 transponders on each satellite. In order to minimize interference between the transponders, the signals are transmitted with alternately polarized antennas. Each satellite occupies a particular location in orbit, and operates at a particular frequency assigned by the FCC. The signals received at the satellite from a ground-based antenna are extremely weak in amplitude—much less than one watt. As a result, they must employ amplifiers that boost the signals to a level that can successfully be processed and retransmitted to the earth.

After traveling 22,000 miles to a ground-based antenna, the signals are again very weak and must be amplified. Therefore, satellite ““dishes”” focus the signals onto the actual antenna. The signals from the antenna are then fed to a ““low-noise block”” amplifier or LNB which amplifies signal and converts them to a lower frequency. The lower the power of the satellite, the larger the antenna required to focus the signals. A C-Band satellite, with power ranging between 10 and 17 watts per transponder, typically has an antenna between 5 and 10 feet in diameter; whereas a high-powered Ku-Band satellite, with a range of 100 to 200 watts per transponder, only requires an antenna 18 inches in diameter.

The signals from the antenna are fed to an integrated receiver/decoder (IRD), which converts them to a form that can be tuned by a TV set. Every IRD contains a unique address number, which is activated by a satellite programmer to allow it to receive subscription services. In addition, the IRDs modem port is connected to a telephone line, in order to access pay-per-view ordering services and transmit other data. A single IRD can supply one channel choice to one or more TV sets. In order to view two different programs at the same time on two different TV sets, two IRDs are required, one for each TV, and the antenna must be a dual-LNB type.

One of the significant drawbacks to satellite television and also Internet service over the satellite is the large size of the dish or antenna that is required to pull in the signal. In the 1980's and early 1990's satellite television subscribers were required to purchase an antenna that was close to six feet in diameter. Since these antennas had to face south in order to receive the signal from the satellite people were limited to the places where they could place the antenna. As a result, the market for satellite television was hampered due to aesthetics concerns caused by the large antennas. In fact, many municipalities placed serious restrictions on the placement of these antenna through local zoning codes and in fact there were even some municipalities that banned them outright. As technology improved the antennas and permitted them to be made smaller many of the municipal objections to the dishes have been alleviated. However, these antennas are still about a foot in diameter and larger when the rest of the equipment is taken into consideration. The fact that these antennas still are required to be lined up with the satellite continues to create problems for the industry because this requirement can force the homeowner to place the antenna in the front of the house in full view of passersby and their presence can detract from the beauty of the home. In addition, as satellite providers increase the number of channels additional satellites are required to be put in place. As a result, the homeowner that wishes to take advantage of the increased number of channels that are offered by the providers is required to purchase a larger antenna that can receive the signal from additional satellites.

Low profile antennas are also needed in other applications as well. When wireless communications are attempted on a moving vehicle particularly one that is undergoing motion in three dimensions there is a need for the communications platform whether it be a boat or a plane or other transportation apparatus to have the platform stabilized to permit accurate and complete reception. One of the problems with current wireless modems is that they are primarily based on cell phone technology whereby there are cells across the country that the modem can operate. While there are many parts of the country that have reasonably good cell phone coverage, there are still vast areas where there are gaps in the coverage. As a result, it is difficult for wireless modems to operate successfully when traveling in many areas. While access to a network is better in a motor vehicle is better than other modes of transportation there are still significant dead areas. The problem of dead areas is exacerbated in a plane due to the high speed of travel as well as the tendency for many routes to bypass populated areas where the cell network infrastructure is more complete. Wireless modem operation is also particularly problematical in boats because these modes of transportation are often great distances from shore. Wireless communication cells are primarily land based and their coverage does not extend over water for any distance. As a result, as you travel further from shore the boat leaves the cell area and access to a computer network weakens or is lost.

One solution to the problem of wireless television reception and wireless computer network access in mobile situations is the use of satellites. Satellites cover vast areas of the country at the present time. In addition, satellites do not have the problem of not being available over water as does other forms of wireless communication. One of the significant drawbacks to satellite transmission and also Internet service over the satellite is the large size of the dish or antenna that is required to pull in the signal. In addition, since these antennas had to face the satellite in order to receive the signal from the satellite the antenna needs to be mobile so that it can rotate as a vehicle travels so that the antenna faces the satellite, i.e., typically a southerly direction. Even as technology has improved over the last few years and antenna have gotten smaller the size of the antenna is still too large for small planes boat car and many other vehicles. Currently, the typical satellite antenna is still about a foot in diameter and larger when the rest of the equipment is taken into consideration.

One type of antenna particularly useful in applications for receiving signals from satellites is the phased array antenna. The most common antennas are the wire type antennas used in radio, television and cellular telephones. There are also the reflector/horn antennas that can be found in direct broadcast satellite terminals. In addition to being able to radiate and receive electromagnetic waves (EM), an antenna has the property of directing EM energy in a specified direction. By assembling a number of antenna elements to form a phased array, the direction of the main beam (its directivity), which contains the radiation, can be controlled. This is accomplished through the adjustment of the signal amplitude and phase of each antenna element in the array. Accurate pointing of the beam in the desired direction minimizes radiation in the unwanted direction, and it improves the signal-to-noise ratio and the overall efficiency of the system.

There are two kinds of phased arrays: passive and active. A passive phased array can produce a main beam but only in a fixed direction, while an active phased array is capable of dynamic beam scanning. A passive array is adequate for communications with satellites in a geosynchronous orbit above the equator; but for tracking low-Earth-orbiting satellites, an active phased array is preferred. The most common approach toward achieving fast-beam scanning is through the integration of monolithic microwave integrated circuit (MMIC) phase shifters with the antenna elements. These circuits are very small and they resemble those found in personal computers. One drawback of an MMIC phased array is the high cost, which limits its applications for commercial communications. As a result, there is a need for lower cost antennas and antennas that have a low profile to better blend into the architecture of a building.

### OBJECTS OF THE INVENTION

It is an object of the invention to provide an antenna that has a low profile that is aesthetically pleasing to the building owner and that does not unnecessarily detract from the architecture of the building.

It is an object of the present invention to provide an improved antenna that is capable of providing broadband connectivity through a satellite.

It is an object of the present invention to provide an improved antenna that is capable of providing television reception and/or Internet connectivity through a satellite.

It is an object of the present invention to provide an improved phased array antenna.

It is an object of the present invention to provide an improved phased array antenna that has a low profile.

It is a further object of the invention to provide an improved phased array antenna that uses MEMS technology.

It is an object of the present invention to provide an improved antenna that uses MEMS technology in conjunction with a ferro-electric sheet.

It is an object of the present invention to provide an improved antenna that is capable of providing broadband connectivity through a satellite to a moving vehicle.

It is an object of the present invention to provide an improved antenna that is capable of providing television reception and/or Internet connectivity through a satellite to a moving vehicle.

It is an object of the present invention to provide an improved phased array antenna for use in mobile applications.

It is an object of the present invention to provide an improved phased array antenna for mobile application that has a low profile.

### BRIEF DESCRIPTION OF THE DRAWINGS

FIG. 1 is a low profile phased array housing of the antenna of the present invention depicted on a roof surface.

FIG. 2 is a low profile phased array housing of the antenna of the present invention as shown on a wall surface.

FIG. 3 is an overview of the operation of the antenna of the present invention where there are multiple satellites.

FIG. 4 shows the low profile phased array antenna of the present invention as used on a number of vehicle types.

FIG. 5 shows the low profile antenna of the present invention with a polarization grid.

FIG. 6 shows a schematic of the hybrid scan antenna of the present invention.

FIG. 7 shows a schematic of the circular polarization switching antenna of the present invention using a fixed (non rotating) grid of wires.

FIG. 8 shows a schematic of the circular polarization switching antenna of the present invention using a rotating grid of wires.

FIG. 9 shows a low profile multi-satellite receiver of the present invention with scanning beam & polarization selection.

FIG. 10 shows a low profile multi-satellite receiver of the present invention with electronic beam scanning in two planes.

FIG. 11 shows a low profile multi-satellite hybrid scanning antenna of the present invention with polarization diversity on transmit and receive.

FIG. 12 shows a low profile dual hybrid scan antenna of the present invention for tracking two moving satellites.

FIG. 13 shows an example of the polarization control for the an antenna of the present invention.

FIG. 14a shows an example of dual linear polarization control for the an antenna of the present invention.

FIG. 14b shows an example of dual circular polarization control for the an antenna of the present invention.

FIG. 15 shows a MEMS phased array antenna of the present invention.

FIG. 16 shows a full duplex hybrid scan with simultaneous multi-satellite receiver operation.

FIG. 17 is an example of an alternative embodiment of an antenna of the present invention.

FIG. 18 shows a subdish of the antenna of FIG. 17 with a polarized flat wire grid.

FIG. 19 is a rear view of the antenna of FIG. 17 showing the beam steering controller CCA.

FIG. 20 illustrates the twist reflect properties of the antenna of FIG. 17.

FIG. 21 shows a traditional reflect array.

FIG. 22 shows representative dimensions of the antenna of FIG. 17.

FIG. 23 shows the relationship between element spacing and maximum scan angle.

FIG. 24 shows circularly polarized alternatives of the antenna of FIG. 17.

FIGS. 25A-25C show representative cross sectional views of the array layout of the antenna of FIG. 17.

FIG. 26 shows the beam steering approach functional block diagram.

FIG. 27 shows an example of the beam-steering unit of the antenna of the present invention.

### DETAILED DESCRIPTION OF THE INVENTION

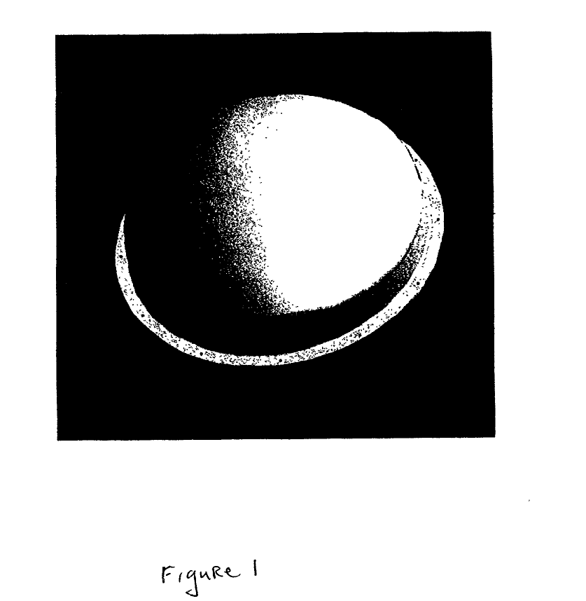

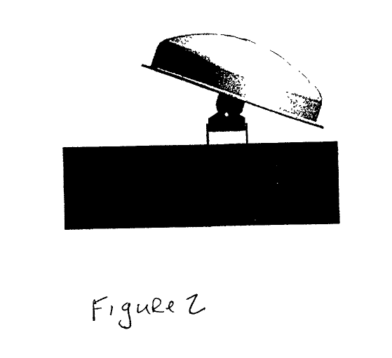

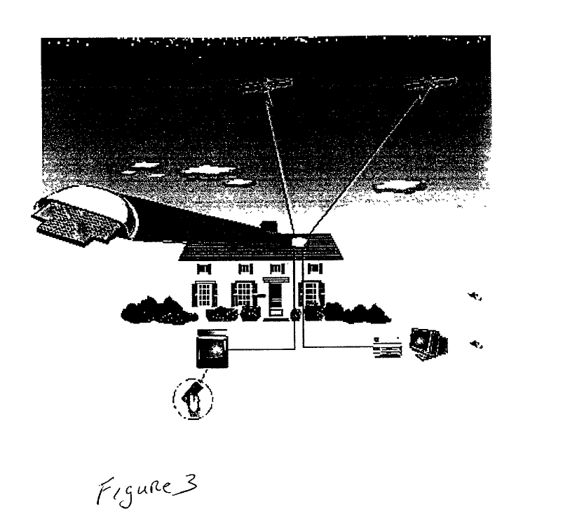

FIG. 1 shows an improved phased array antenna of the present invention. The antenna of the present invention covers either the Ka or the Ku band or both and can be used for other bands if desired. The antenna of the present invention may be any size desired, however, the antennas of the present invention may be considerably smaller that the typical phased array antenna and other types of antennas used for satellite dishes on homes and businesses. Typically, the antenna of the present invention will have a size that is typically about 1 foot in diameter or about 1 foot square or less. The phased array antenna of the present invention may be placed flat on a roof or other surface as shown in FIG. 2C or may be mounted on a mounting means as shown in FIGS. 2A and 2B. The mounting means may have a plate 20 that is flush mounted on a surface. Extending upwardly from the upper surface of the plate 21 are a pair of mounting flanges 22 and 23 that are joined by a base member 24. Base member 24 supports the base 25 of the antenna. The base 25 of the antenna provides a means for the angle of the antenna to be adjusted so that the antenna will be aligned with the appropriate satellite. The antennas of the present invention are for use with GEO satellites as well as LEO/MEO satellites as well.

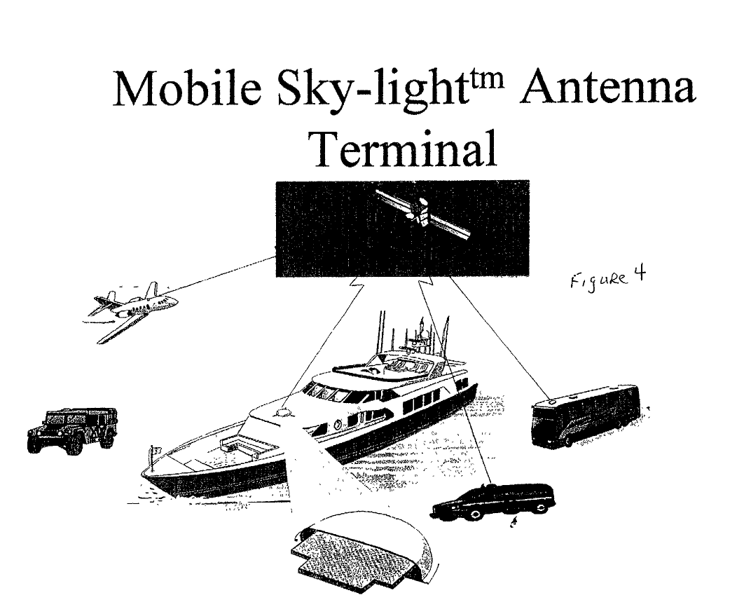

FIG. 34 depicts the antenna of the present invention in position of the roof of a house or other structure and shows the alignment with one or more satellites to provide television and/or Internet connectivity through the satellites. It will be appreciated by those skilled ion the art that the placement of the antenna of the present invention is not limited to buildings but that the antenna can be appended to a variety of devices including vehicles as shown in FIG. 4.

The term phased array antenna as used herein is intended to include but not be limited to antennas that are generally a directive antenna made up of a plurality of individual radiating antenna elements, which generate a radiation pattern or antenna beam having a shape and direction determined by the relative phases and amplitudes of the excitation signal associated with the individual antenna elements. By varying the relative phases of the respective excitation signals, it is possible to steer the direction of the antenna beam. The radiating antenna elements may be provided as dipole antenna elements, open-ended waveguides, slots cut in waveguides, printed circuit antenna elements or any type of antenna element.

The antennas of the present invention can be either 1-D or 2-D phased arrays or dish antennas with phased array and commutated array feeds. The antenna array may be either active or passive. In one embodiment, the antenna may be a passive space fed, planar phased array antenna for 2-D satellite communication, such as SATCOM satellite communication. In a preferred embodiment, the anteenahas two circuit panel assemblies and a feed horn illuminator. The result is an uncomplicated assembly with a minimum number of parts and can do away with the presence of RF connectors, cables, joints or wire bonding across gaps between critical RF components. The array preferably uses a triangular grid closely spaced dual-port printed elements (approximately 0.59λ) for scanning to 60 degrees without grating lobes. There is no RF transmission line to dissipate energy in the path from the input to the aperture other than the phase shifter, thus enhancing antenna efficiency.

The array antenna includes of a number of individual radiating antenna elements suitably spaced with respect to one another. The relative amplitude and phase of the signals applied to each of the antenna elements are controlled to obtain the desired radiation pattern from the combined action of all of the antenna elements. Two common geometrical forms of array antenna are the linear array and the planar array. A linear array antenna includes a plurality of antenna elements arranged in a straight line in one dimension. A planar array antenna is a two-dimensional configuration of antenna elements arranged to lie in a plane. The planar array antenna may thus be thought of a linear array of linear array antennas.

The linear array antenna typically generates a fan beam when the phase relationships are such that the direction of radiation is perpendicular to the array. When the radiation is at some angle other than perpendicular to the array, the linear array antenna generates an antenna beam having a conical shape.

A two-dimensional planar array antenna having a rectangular aperture can produce an antenna beam having a fan-shape. A square or a circular aperture can produce an antenna beam having a relatively narrow or pencil shape. The array can be made to simultaneously generate many search and/or tracking beams with the same aperture.

One particular type of phased array antenna in which the relative phase shift between antenna elements is controlled by electronic devices is referred to as an electronically controlled or electronically scanned phased array antenna. Electronically scanned phased array antennas are typically used in those applications where it is necessary to shift the antenna beam rapidly from one position in space to another or where it is required to obtain information about many targets at a flexible data rate. In an electronically scanned phased array, the antenna elements, the transmitters, the receivers, and the data processing portions of the radar are often designed as a unit.

In some application involving satellites of the type used in the present invention, it is preferable that the antenna system be capable of producing multiple, independent antenna beams. Such antenna systems are advantageous in a variety of different applications including communication satellites, ECM, ESM radar and shared aperture antennas used to accomplish simultaneously a combination of these functions. The present invention has applicability to communication satellite applications, including but not limited to, for example, the simultaneous objectives of relatively high EIRP (Equivalent Isotropically Radiated Power) and G/T (Gain over System Temperature), wide access footprints, channelized operation and a high spectral efficiency (i.e., frequency reuse) leads to the need for multiple, independent antenna beams.

Future rapid deployment of low- and medium-Earth-orbit satellite constellations that will offer various narrow- to wide-band wireless communications services will also use phased-array antennas that feature wide-angle and superagile electronic steering of one or more antenna beams.

Hundreds of low-Earth-orbiting satellites, providing various commercial communications services, are expected to be launched over the next five years. These wideband services may include video phones, interactive TV, the Internet and telemedicine.

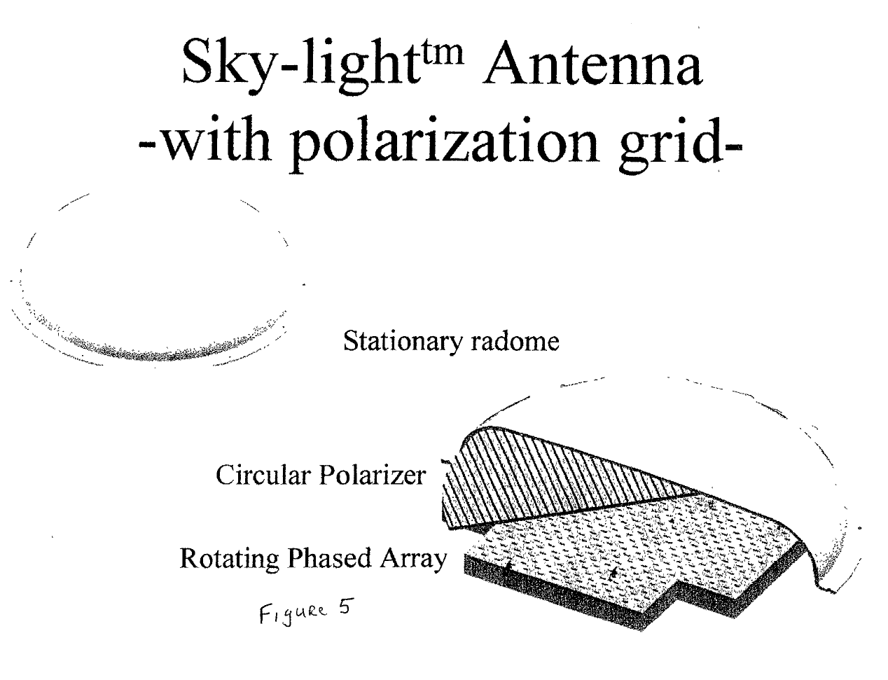

As seen in FIG. 5, the antenna of the present invention has a stationary radome 31 over a polarizer 32. The radome provides environmental protection and the shape may be selected to minimize any aerodynamic effects on the mobile low profile phased array antennas. The material of which the radome is made effects the insertion loss and the shape of the radome affects the antenna pattern. Antenna pattern distortion is usually minimal when a circular radome is used. However, an ogive or ellipsoid shape has a minimum impact on aerodynamic performance. The polarizer in FIG. 5 is shown as being generally circular but it will be appreciated by those skilled in the art that the polarizer need not be circular. Beneath the polarizer is a rotating phased array 33.

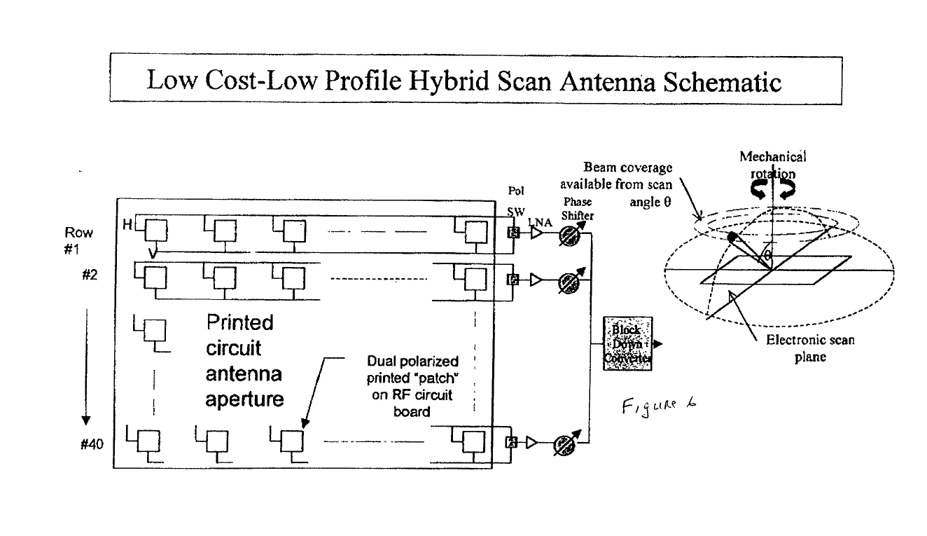

The antenna is scanned electronically, preferably in a single plane and the antenna rotates mechanically about an axis perpendicular to the plane of the aperture. This motion allows a full hemisphere of coverage. The details are shown in FIG. 6. The antenna uses MEMS phase shifter and MEMS switches to provide beam steering and polarization switching. The use of MEMS technology provides significant cost savings in the manufacture of the antenna and permits the antenna to achieve a low profile when mounted. The MEMs phase shifters are preferably 2 bit or 3 bit phase shifters.

Microelectromechanical systems (MEMS) are integrated micro devices or systems combining electrical and mechanical components fabricated using integrated circuit (IC) compatible batch-processing techniques and range in size from micrometers to millimeters. These systems can sense, control, and actuate on the micro scale and function individually or in arrays to generate effects on the macro scale. MEMS can be used to provide miniaturization and integration of simple elements into more complex systems.

The aperture of the of the antenna can be shared to transmit and receive separately or in duplex fashion and is not restricted to the receive mode shown in schematic form in FIG. 6. Planar construction permits the antenna to have a low profile. The antenna may be used for fixed applications such as residential or office building use as well as for mobile use. The antenna is very nearly flush on whatever surface it is applied to and can be mounted on a roof like a skylight or on a vertical surface such as a window. Besides satellite applications, the antenna is also applicable to a large number of non satellite antenna systems such as in LMDS. Circular polarization is preferred because it is insensitive to antenna rotation. Linear polarization can be accommodated by a circuit which automatically adjusts for antenna motion or physical orientation of the antenna.

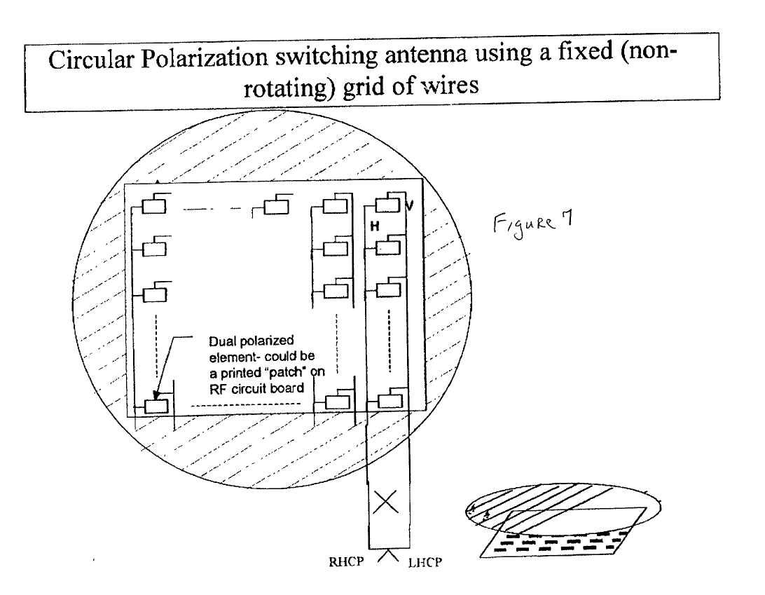

As seen in FIG. 7, there is a circularly switching antenna using a fixed or non rotating grid of wires. In this Figure, the polarization grid can be designed to be frequency selective to permit simultaneous operation of the antenna in linear polarization and circular polarization. This is most useful for a two way transmit such as used in an Internet connection where the antenna is not just receiving a signal but is also transmitting input from a computer for example. Direct PC is an example of this type of communication. In two way communication the grid can be designed to be transparent to circular polarization in one band and convert linear polarization in another band to one of the circularly polarized ports without inherent polarization loss where it can be extracted by a diplexer. This is useful since the uplinks and the downlinks with DBS and FSS satellites are accomplished using different frequency bands.

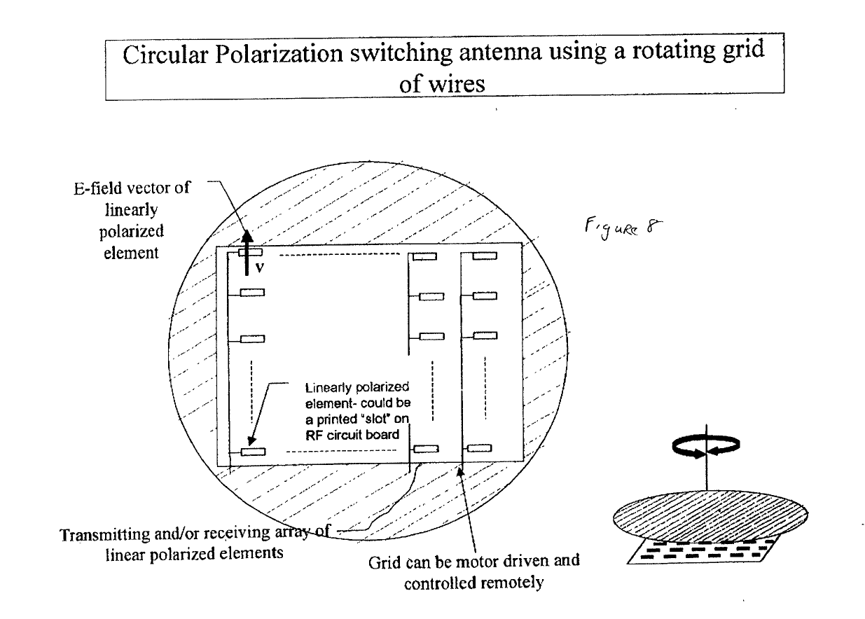

In FIG. 8, there is shown a circular polarization switching antenna using a rotating grid of wires. In this Figure, a single linearly polarized element is used to produce a dual circularly polarized array and the use of a plurality of RF polarization switches is eliminated. A multi-layer polarization grid converts linear polarization to circular. If the grid is physically rotated ±90° relative to linear polarized antenna elements, the sense of circular polarization is switched, i.e., RHCP to LHCP. If linear and circular polarization are both desired, the grid is rotated only 45° so the wires are perpendicular to the linear polarization and vector V produces a linear polarized beam. The rotation of the grid can be motor driven and preferably controlled remotely.

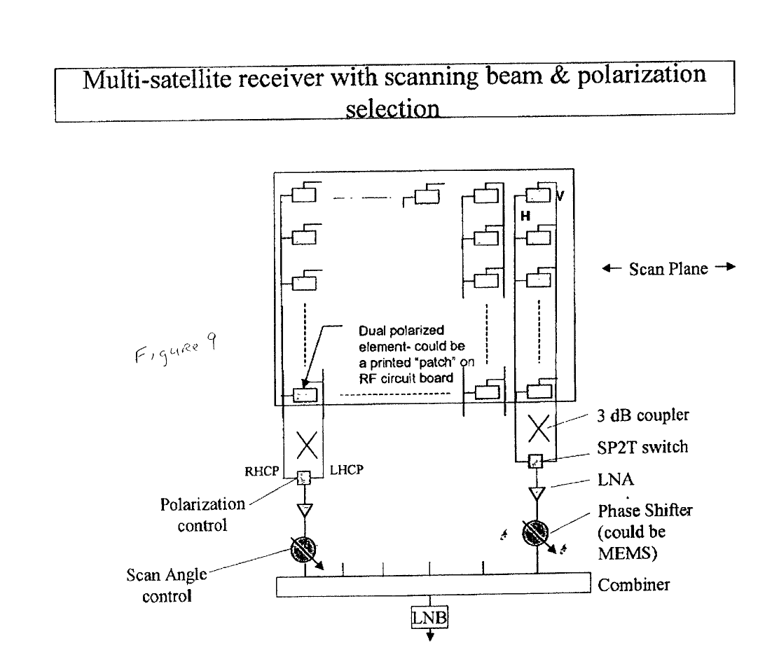

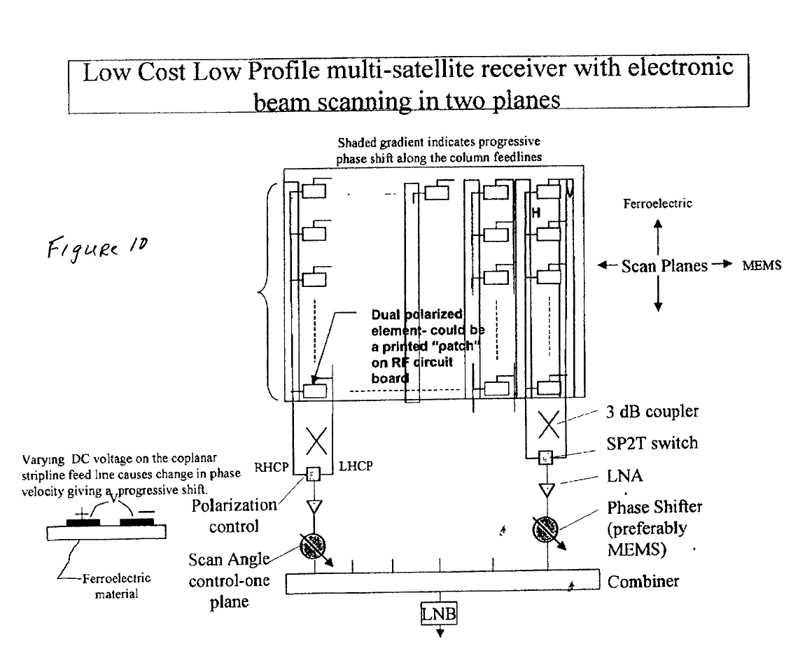

A multi-satellite receiver with scanning beam and polarization selection is shown in FIG. 9. In FIG. 10, a low profile multi-satellite receiver is shown with electronic beam scanning in two planes. In the receiver of FIG. 10, each column feedline is covered by a ferroelectric coating rendering its phase velocity electrically controllable. When each feedline is excited by the same control voltage, V, one plane scanning is produced with a simple electric circuit. Scanning in the orthogonal plane is done by discrete MEMS phase shifters resulting in a fully phased array. As seen in FIG. 10, the shaded gradient indicates progressive phase shifting along the column feedlines. By varying the DC voltage on the coplanar stripline feed line causes change in phase velocity giving a progressive shift.

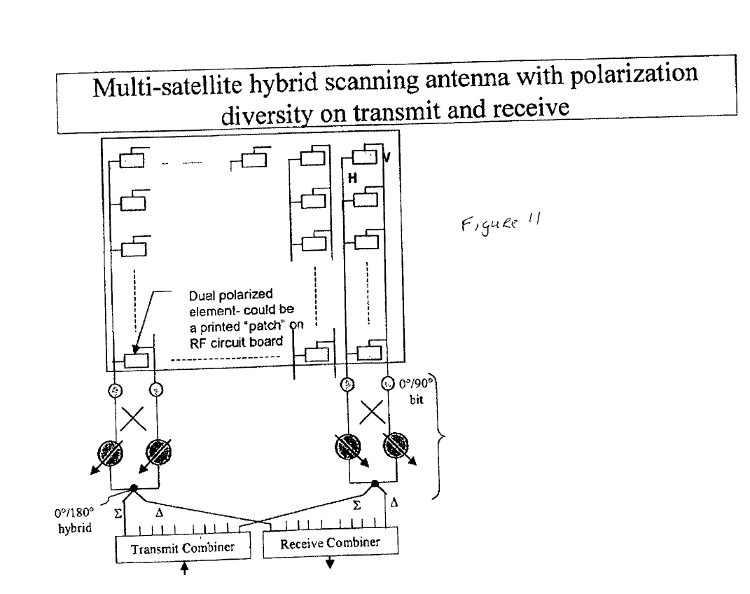

The embodiment shown in FIG. 11 is a multi-satellite hybrid scanning antenna with polarization diversity on both transmit and receive. The antenna shown in FIG. 11 is capable of receiving from and transmitting to a satellite of arbitrary polarization. In mobile applications, the orientation of linear polarization can be adjusted for optimum performance. The network shown in FIG. 11 can generate arbitrary orthogonal polarizations at the sum and difference ports (Σ and Δ). The arbitrary orthogonal polarizations can be used to communicate with a variety of satellites which exhibit different polarization characteristics. For example, a service such as Direct TV uses dual circular while Direct PC uses dual linear. This capability also allows automatic adjustment of the antennas polarization to compensate for the degradation in polarization versus scan angle typically experienced with wide scan phased arrays. It is also useful for mobile applications using linearly polarized satellites.

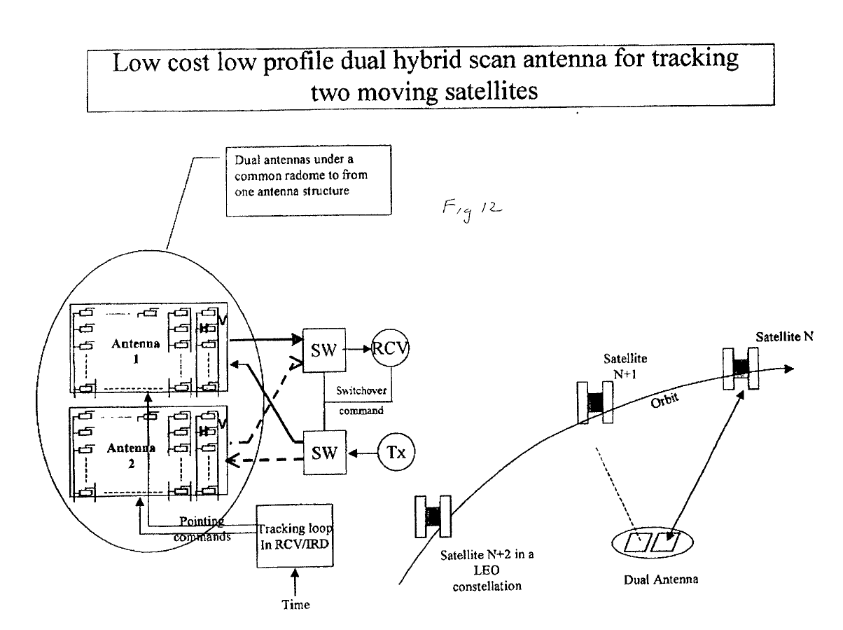

FIG. 12 shows a low profile dual hybrid scan antenna for tracking two moving satellites. One antenna communicates while the second antenna is pointed at the on-coming satellite whose positions are always known. The switch to the second antenna is made on command from the satellite, and the first antenna resumes the role of pointing at the next oncoming satellite and so on. Switching occurs typically every 10-20 minutes. The orbital positions are stored in the tracking loop and an accurate clock tells the antenna where to point.

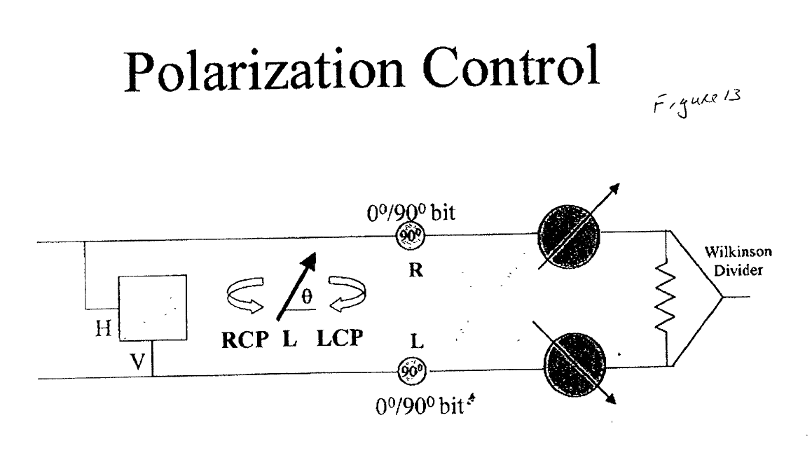

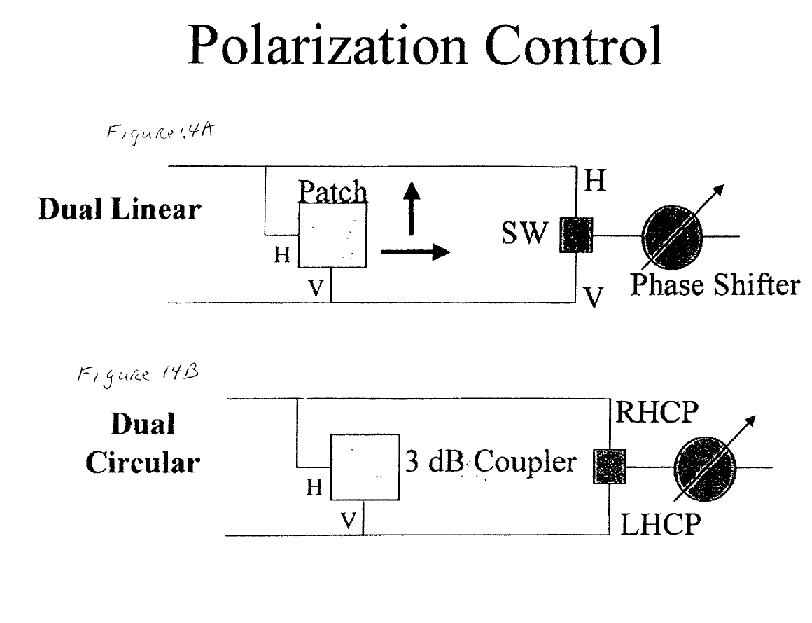

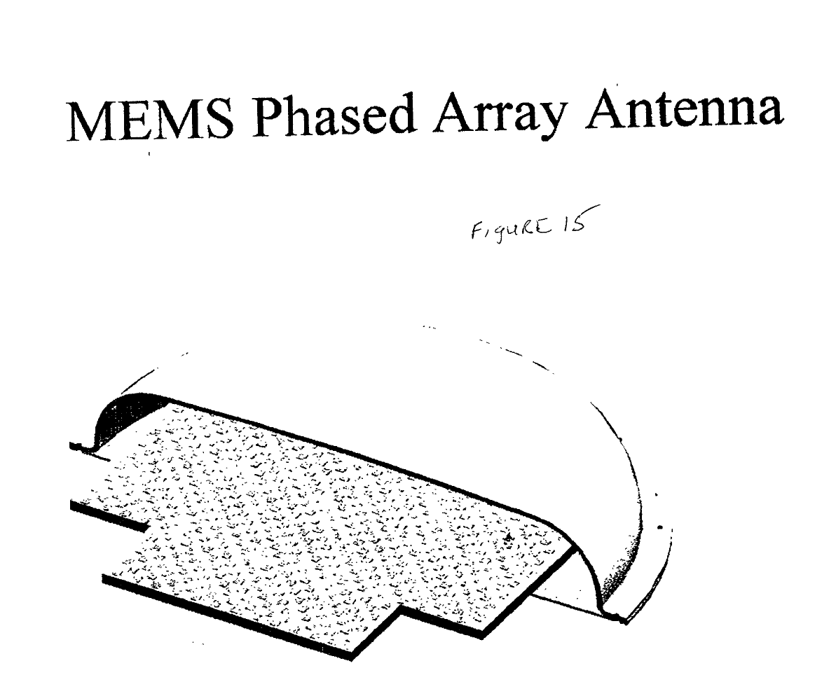

Polarization control is shown in FIG. 13. the average phase steers the beam. The phase difference controls orientation of linear polarization, θ. Ninety degree bits are used to provide R or L circular polarization. Any elliptical polarization can be generated. Polarization control for a dual linear and a dual circular phased array antenna are shown in FIGS. 14A and 14B respectively. FIG. 15 shows a cutaway view of the improved antenna of the present invention.

Satellite communications (satcom) systems operating at microwave carrier frequencies (between 3 GHz and 300 GHz) typically employ parabolic reflector antennas through which signals from the satellite (downlink signals) are received while signals to the satellite (uplink signals) are simultaneously transmitted. The parabolic reflector is typically illuminated for both the uplink and the downlink by a single feed horn that supports all signal polarizations. In most satcom systems, the uplink signal frequency is somewhat higher than the downlink signal frequency. In typical Ku-band systems, for example, the uplink frequency is commonly in the range 14.0 GHz-14.5 GHz while the downlink frequency is commonly in the range 10.95 GHz-12.75 GHz.

In most satcom systems, the uplink signal polarization is specified by the communications system to be orthogonal to the polarization of the downlink signal in order to minimize cross-talk between the uplink and downlink signals. In these cross-polarized systems, the circular waveguide feed horn is connected to an orthomode transducer (OMT) to separate the orthogonally polarized uplink and downlink signals. The OMT may also include a transmit frequency band reject filter in the receive arm of the OMT. Each of the orthogonal arms of the OMT is in turn connected to an associated filter and to separate receiver and transmitter hardware in rectangular waveguide. Some satcom systems are designed so that the uplink and downlink signals have the same polarization (i.e. they are co-polarized), even though associated signal cross-talk problems may thus be encountered.

The antenna of the present invention may employ a low profile full duplex hybrid scan with simultaneous multi-satellite receiver operation using distributed diplexers. This feature has particular applicability in the area of satellite transmission of television signals such as Direct TV and satellite transmission of wireless computer network communications such as Direct PC.

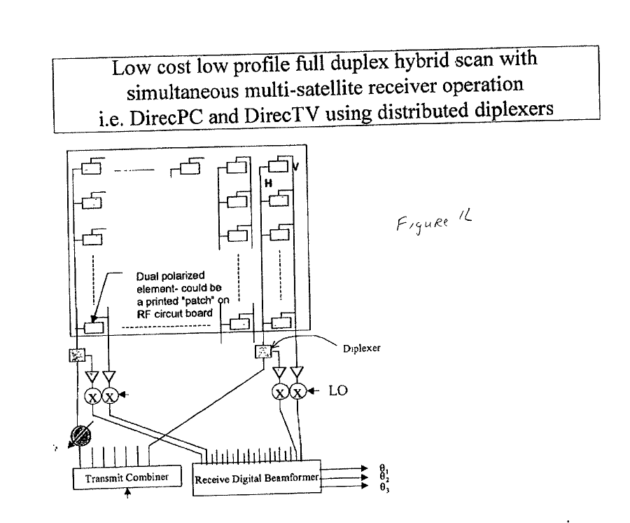

In such applications, the transmit frequency occurs in a different band for Direct PC than the receive frequency. The transmit frequency for Direct PC is in the range of 14 to 14.5 Ghz. The receive frequency band is 11.7 to 12.7 GHz. As shown in FIG. 16, a diplexer is employed to implement in a distributed fashion. The diplexer can be printed on an RF circuit board to reduce costs.

A digital beamformer takes the two orthoginal polarized receive signal and amplifies them in an low noise amplifier (LNA). The beamformer then down coverts the received signals to a lower frequency signal which is converted to a digital signal and processed in an array to form the beam signal. Multiple simultaneous beams can be created in this manner. The beam angles can be inputted as a command from the integrated reception demodulator (IRD). An automatic tracking means can be present in the event there is relative motion between satellites and ground equipment.

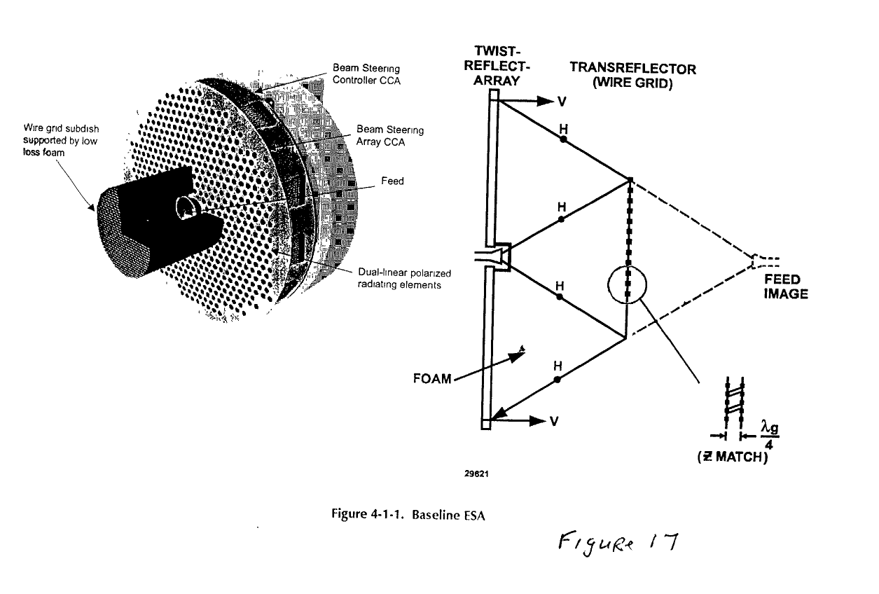

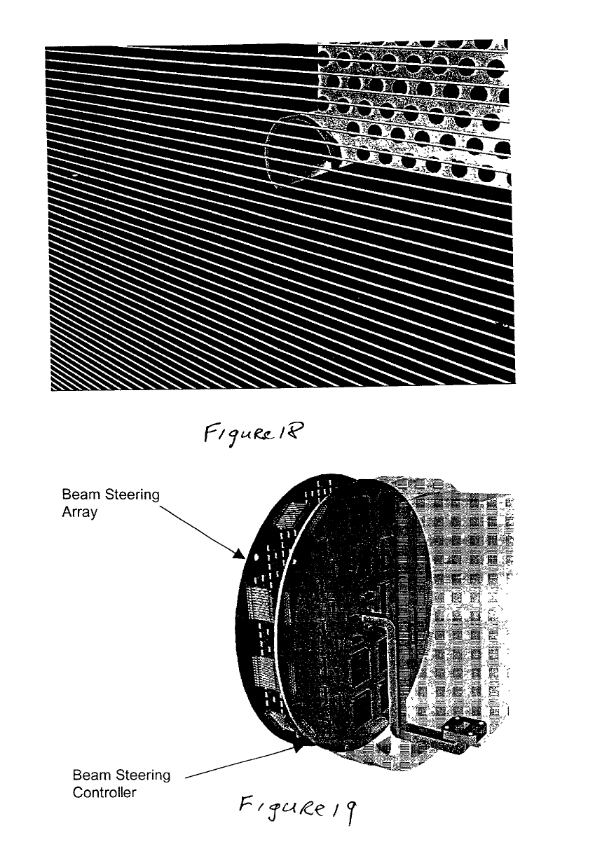

A rendering of an example of another embodiment of the antenna of the present invention is shown in FIGS. 17 to 27. The antenna is a linearly polarized Cassegrain-fed reflectarray but with twist reflecting properties. The subdish is a polarized flat wire grid (shown in FIG. 18) supported by a very low loss and low effective K closed-cell filled with voids foam (not shown). Linear polarization from the feed is reflected by the closely spaced wires, illuminating the array element in the same polarization. The signal captured by the element is phase shifted and re-radiated out the orthogonal port of the element. The radiated orthogonal linear polarization passes thorough the wires with little effect. The twisting action of the array is described further below as it applies to any polarization emanating from the feed. The subdish can be made large because it is transparent to the radiated beam. This permits an efficient illumination system with low blockage from a small feed aperture.

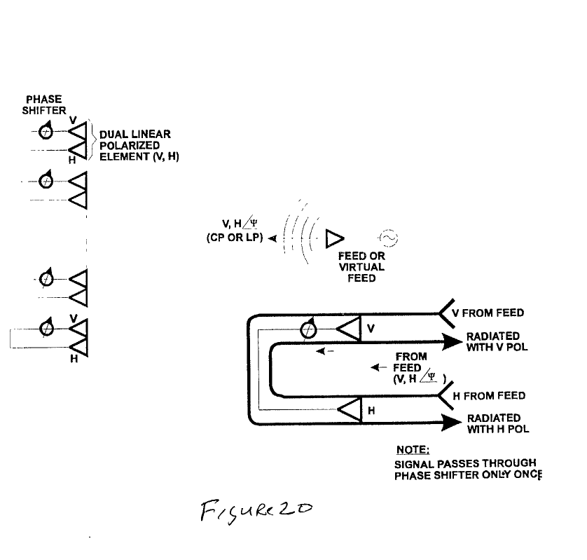

The array portion of the antenna may have two multi-layer printed circuit board assemblies. One is a Beam Steering Array CCA. It preferably contains approximately 590 printed radiating elements on an equilateral triangular grid on the front (radiating) side of the board, a plurality of MEMS phase shifter packages and a plurality of control ASICs on the rear side. The number of MEMS phase shifters can be upwards of 295 or more and about 149 or more control ASICS. The RF PCB may be made of Rogers R-4003, with the other layers being 0.004″ FRG. Preferably, the antenna incorporates two phase shifters in each MEMS package to reduce the cost and number of component insertions at the assembly level. One ASIC controls four phase shifters for similar reasons. The second board is called the beam Steering Controller CCA (rear PCB in FIG. 19), which generates and distributes the steering commands for each element. Board to board connectors interconnect the two CCA's.

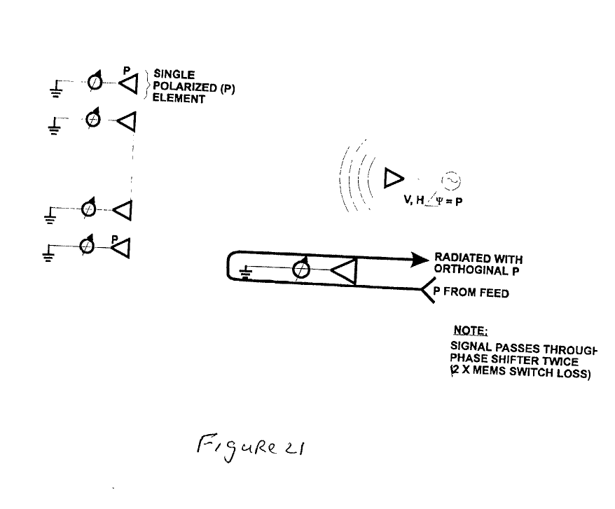

Although linear polarization is radiated from the array, the antenna can use a dual linearly polarized element so that it is inherently capable or radiating any polarization generated by the feed (linear or circular, fixed or switchable). In the seeker application, this dual polarized element can provide twist reflect properties. FIG. 20 illustrates this capability. The figure shows dual linearly polarized elements with a port (feed point) for each orthogonal polarization vertical (V) and horizontal (H). An example illustrates the behavior with a vertically polarized feed. The signal incident on the element excites the vertically polarized port and re-radiates it from the horizontally polarized port. The radiation from the antenna is orthogonal to the feed radiation. The array acts like a twist reflector hence the name Twist Reflect Array. In a second example, the feed illuminates the elements with any polarization such as circular (RHCP). The vertical and horizontal components of this incident circularly polarized field are excited in the respective ports of the element and each component is shifted in phase and re-radiated out the orthogonal port. A key point is that the signals preferably pass through the phase shifter only once. The polarization of the radiated beam, RHCP in this case is orthogonal to the polarization normally generated by a symmetrical reflector (the array), or the traditional reflectarray. The benefit of the TwistReflectArray over the traditional reflectarray besides polarization diversity, is its lower insertion loss.

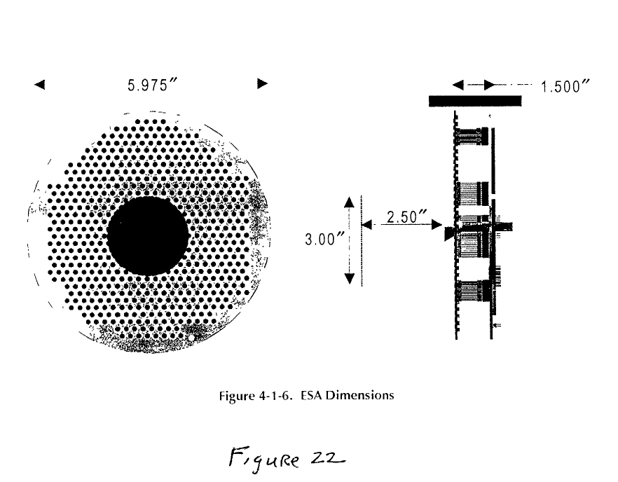

FIG. 21 illuminates that with the traditional reflect array only one port is provided on the element. Therefore, the signal passes through the phase shifter twice experiencing twice the number of MEMS switches and reference lines for a switched-bit phase shifter. A 3-bit switched bit phase shifter has about 2 dB of IL. Twice through. the IL would be 4 dB, making the traditional reflect array not as attractive. Other advantages of the Twist Reflect Array include independent impedance matching of the orthogonal ports of the element (when linear polarization is radiated by the feed). This enables the array to be matched to the radiation from the feed while optimizing the impedance of the array over the scan range. Lastly, a linearly polarized Twist Reflect Array provides the means to reduce feed blockage by using a large polarized subreflector (trans-reflector) made of a wire grid.

The antenna of the present invention may also use linear co-polarization. The baseline feed for the antenna is a horn and flat subdish made of printed wires on a thin dielectric supported by a closed-cell foam block filled with many voids.

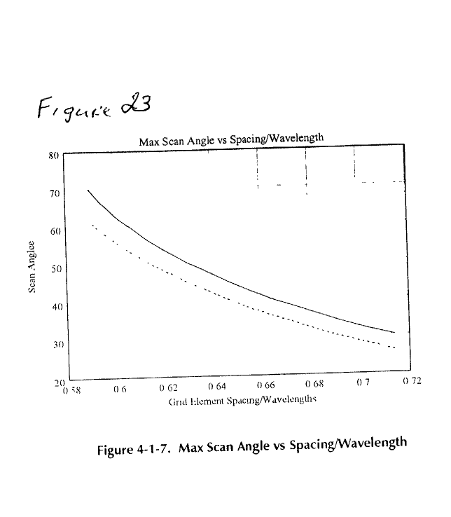

The approximate dimensions of the antenna of the present invention are shown in FIG. 22. The feed arrangement for the TwistReflectArray fits nicely into a low profile radome and minimizes the overall size of the seeker The weight of the antenna array is less than one pound. The input medium is waveguide and may connect directly to the RF head by a flange. The foam support for the reflector grid is made of several layers with holes in it, so the composite is mostly air.

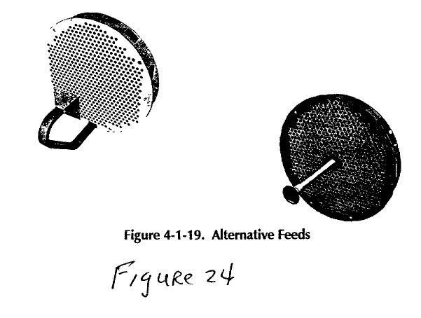

The array elements may be arranged on an equilateral triangular grid. This grid was chosen to permit scanning out to 60° in any plane while keeping the main beam of the nearest grating lobe outside of “real space”. The relationship between element spacing and maximum scan angle is shown in FIG. 23. The upper curve is for an infinite array. The lower curve represents the ESA with a 3.5° beam width. The grid spacing chosen is 0.59λ at the high end of the frequency band. This results in the minimum number of elements (590) to cover the conical scar volume of the system.

The linearly polarized feed provides the array illumination, from a small horn. The f/D shown is approximately 0.8. This is chosen to keep the angle small from the edge of the subdish to the outer element. The taper at the edge of the array is approximately −10 dB, chosen as a reasonable tradeoff between spillover and blockage. The large wire grid subdish reflects the feed radiation towards the array. The subdish is reasonably large to reduce spillover yet is transparent to the radiated focused beam. The size of the sub-dish can be as large as the radome cross-section allows, nearly the full extend of the array. In this case, the wire subdish also acts as a polarization filter, further suppressing cross-polarized radiation from the array and any feed spillover.

Impedence matching is provided inside the horn to cancel any radiation reflected back into the feed. The feed assembly has a circularly symmetric cross section. Printing wires on a thin Mylar or other suitable dielectric film forms the subdish. To minimize mismatch to the beam that passes through the subdish, two grids can be used or thin capacitive films proper with the spacing to form a wide angle impedance match. The closed cell foam support contains voids to further minimize the effective dielectric constant and loss tangent of the foam. The horn would be a thin-walled, low mass, precision casting or Electro-formed assembly.

The transverse location of the feed is critical for accurate beam pointing, The phase center must be located on the array boresight within a few mils to keep the bias error negligible. An alignment fixture is used at assembly of the ESA to achieve this. The fixture picks up tooling points on the antenna array face (PCB) and the feed. The fixture quickly locates the feed in production minimizing alignment costs. Calibration removes the residual error. Also alignment of the wires on the subdish must be parallel to the feed polarization; this is also accomplished with the tool. The axial location of the feed is less critical and does not cause a beam pointing bias error. Mechanical tolerances alone should locate the feed axially within its tolerance window.

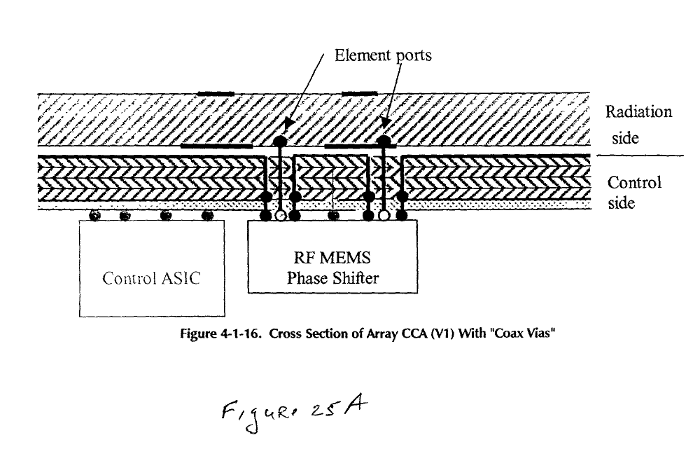

There are two circularly polarized alternatives. These are shown in FIG. 24. One is a front-fed horn. It is attractive for its design simplicity. Here, the feed would use a combination of modes in the horn to sharpen the radiation pattern towards the edge of the array to control spillover. The second is a more conventional Cassegrain feed and subdish.

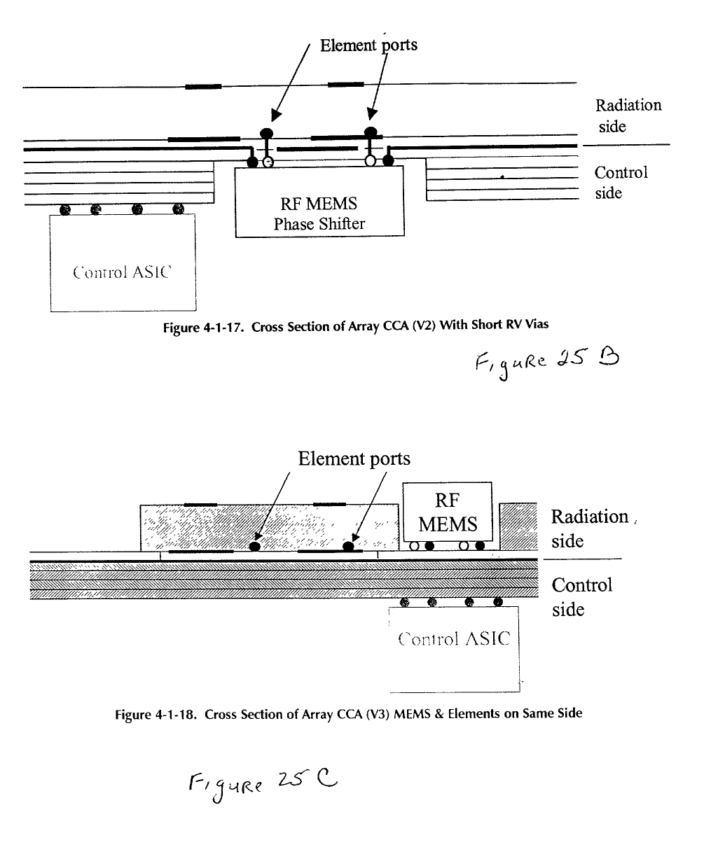

The MEMS phase shifters uses electrostatic actuation for rapid switching and low drive power consumption. The metal-metal contact configuration enables low-loss operation over a broad frequency range. The device configuration is based on a dielectric structural providing inherent isolation between the drive and signal lines. FIGS. 25A-25C show representative cross sectional views of the array layout.

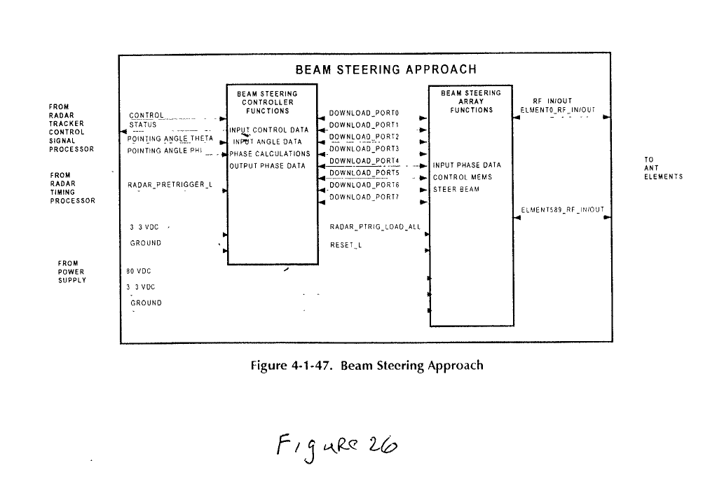

The seeker Bean Steering Unit (BSU) steers the seeker” antenna beam as a function of pointing angle commands from the radar tracker control signal processor at a specified update rate. The beam steering approach functional block diagram is shown in FIG. 26.

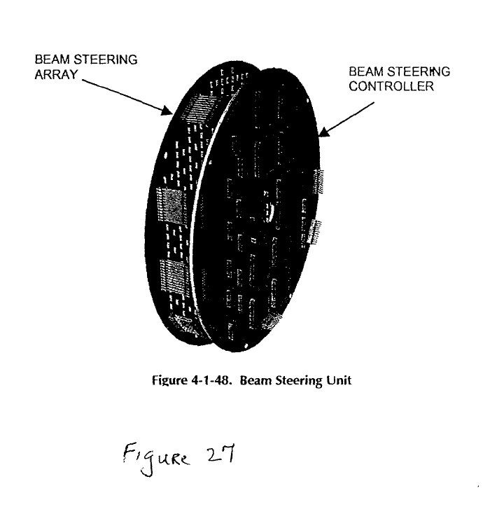

The beam-steering unit is shown in FIG. 27. The BSU receives commands from the radar tracker control signal processor, receives radar pre-triggers from the radar timing processor, calculates the phase data for each MEMS phase shifter element it the Antenna Array, downloads the phase data to the beam steering array MENS phase shifters to electronically steer the antenna beam and provides status to the radar tracker control signal Processor. The seeker beam steering approach is simple, flexible and cost effective The approach divides the design into two physical blocks, a beam steering controller and the beam steering array. Functionally the beam steering controller receives angles and control commands from the radar tracker control signal processor, performs phase calculations, downloads the phase data to the beam steering array using download ports 0 to 7 and updates the beam-steering array with the radar pre-trigger (RADAR_PTRIG_LOAD_ALL) to steer the antenna beam. The beam steering array receives the phase data controls the MEMS phase shifters and steer the beam.

We claim:

1. An improved phased array antenna having a low profile comprising a polarizer and a rotating phased array, MEMS phase shifters for electronically controlling relative phase shift between antenna elements and MEMS switches to provide beam steering and polarization switching.

2. The antenna according to claim 1 wherein the array is linear.

3. The antenna according to claim 3 wherein the array is planar.

4. The antenna according to claim 1 being capable of producing multiple, independent antenna beams.

5. The antenna according to claim 1 wherein the polarizer is a polarization grid designed to be frequency selective to permit simultaneous operation of the antenna in linear polarization and circular polarization.

6. The antenna according to claim 1 wherein the polarizer is a rotating grid of wires.

7. The antenna according to claim 1 wherein there is electronic beam scanning in two planes.

8. The antenna according to claim 1 further comprising a receiver having one or more column feedlines and wherein each column feedline is covered by a ferro-electric coating rendering its phase velocity electrically controllable.
